(19) United States
(12) Patent Application Publication
(10) Pub. No.: US 2023/0290047 A1
(43) Pub. Date: Sep. 14, 2023

(54) INTERACTIONS DURING A VIDEO EXPERIENCE

(71) Applicant: APPLE INC., Cupertino, CA (US)

(72) Inventors: Benjamin H. BOESEL, Sunnyvale, CA (US); Emilie KIM, San Francisco, CA (US); David H. HUANG, San Mateo, CA (US); Shih-Sang (Carnaven) CHIU, Menlo Park, CA (US)

(21) Appl. No.: 18/110,916

(22) Filed: Feb. 17, 2023

Related U.S. Application Data
(63) Continuation of application No. PCT/US2021/045489, filed on Aug. 11, 2021.
(60) Provisional application No. 63/068,602, filed on Aug. 21, 2020.

(51) Int. Cl. G06T 15/40; G06T 19/00

(52) U.S. Cl. CPC G06T 15/40; G06T 19/006

(57) ABSTRACT

Various implementations disclosed herein include devices, systems, and methods that adjusts content during an immersive experience. For example, an example process may include presenting a representation of a physical environment using content from a sensor located in the physical environment, detecting an object in the physical environment using the sensor, presenting a video, wherein the presented video occludes a portion of the presented representation of the physical environment, presenting a representation of the detected object, and in accordance with determining that the detected object meets a set of criteria, adjusting a level of occlusion of the presented representation of the detected object by the presented video, where the representation of the detected object indicates at least an estimate of a position between the sensor and the detected object, and is at least partially occluded by the presented video.

### CROSS-REFERENCE TO RELATED APPLICATIONS

This patent application is a continuation of International Application No. PCT/US2021/045489 filed on Aug. 11, 2021, which claims the benefit of U.S. Provisional Application No. 63/068,602 filed on Aug. 21, 2020, entitled “INTERACTIONS DURING A VIDEO EXPERIENCE,” each of which is incorporated herein by this reference in its entirety.

### TECHNICAL FIELD

The present disclosure generally relates to systems, methods, and devices for presenting views of virtual content and a physical environment on an electronic device, including, providing views that selectively display detected objects of the physical environment while presenting virtual content.

### BACKGROUND

A view presented on a display of an electronic device may include virtual content and the physical environment of the electronic device. For example, a view may include a virtual object within the user's living room. Such virtual content may obstruct at least a subset of the physical environment that would otherwise be visible if the virtual content were not included in the view.

### SUMMARY

Various implementations disclosed herein include devices, systems, and methods for controlling interactions (e.g., controlling a level of occlusion) from physical objects while presenting extended reality (XR) environments (e.g., during an immersive experience) on an electronic device. For example, controlling interactions from real world people, pets, and other objects (e.g., objects that may be presenting attention seeking behavior) while a user is watching content (e.g., a movie/tv) on a virtual screen using a device (e.g., an HMD) that supports video pass-through. In an immersive experience, the virtual screen may be given preference over passthrough content so that passthrough content that comes between the user and the virtual screen is hidden so it does not occlude the virtual screen. Some real-world objects, e.g., people, may be identified and the user may be cued to the existence of the person, for example, by displaying an avatar (e.g., a silhouette or a shadow that represents the person). Additionally, the system may recognize that a person (or pet) is seeking the attention of user and further adjust the experience accordingly.

In general, one aspect of the subject matter described in this specification can be embodied in methods that include the actions of presenting a representation of a physical environment using content obtained using a sensor located in the physical environment, presenting a video, wherein the presented video occludes a portion of the presented representation of the physical environment, detecting an object in the physical environment using the sensor, presenting a representation of the detected object, wherein the representation of the detected object indicates at least an estimate of a position between the sensor and the detected object, and is at least partially occluded by the presented video, and in accordance with determining that the detected object meets a set of criteria, adjusting a level of occlusion of the presented representation of the detected object by the presented video.

These and other embodiments can each optionally include one or more of the following features.

In some aspects, determining that the detected object meets the set of criteria includes determining that an object type of the detected object meets the set of criteria.

In some aspects, detecting the object in the physical environment includes determining a location of the object, and determining that the detected object meets the set of criteria includes determining that the location of the detected object meets the set of criteria.

In some aspects, detecting the object in the physical environment includes determining a movement of the detected object, and determining that the detected object meets the set of criteria includes determining that the movement of the detected object meets the set of criteria.

In some aspects, the detected object is a person, and determining that the detected object meets the set of criteria includes determining that an identity of the person meets the set of criteria.

In some aspects, the detected object is a person, detecting the object in the physical environment includes determining speech associated with the person, and determining that the detected object meets the set of criteria includes determining that the speech associated with the person meets the set of criteria.

In some aspects, the detected object is a person, and detecting the object in the physical environment includes determining a gaze direction of the person, and determining that the detected object meets the set of criteria includes determining that the gaze direction of the person meets the set of criteria.

In some aspects, adjusting the level of occlusion of the presented representation of the detected object is based on how much of the representation of the content includes virtual content compared to physical content of the physical environment.

In some aspects, in accordance with determining that the detected object meets the set of criteria, the method may further include pausing the playback of the video. In some aspects, in accordance with determining that the detected object meets a second set of criteria, the method may further include resuming playback of the video. In some aspects, the playback of the video is resumed using video content prior to the pausing.

In accordance with some implementations, a device includes one or more processors, a non-transitory memory, and one or more programs; the one or more programs are stored in the non-transitory memory and configured to be executed by the one or more processors and the one or more programs include instructions for performing or causing performance of any of the methods described herein. In accordance with some implementations, a non-transitory computer readable storage medium has stored therein instructions, which, when executed by one or more processors of a device, cause the device to perform or cause performance of any of the methods described herein. In accordance with some implementations, a device includes: one or more processors, a non-transitory memory, and means for performing or causing performance of any of the methods described herein.

### BRIEF DESCRIPTION OF THE DRAWINGS

So that the present disclosure can be understood by those of ordinary skill in the art, a more detailed description may be had by reference to aspects of some illustrative implementations, some of which are shown in the accompanying drawings.

FIG. 1 is an example operating environment in accordance with some implementations.

FIG. 2 is an example device in accordance with some implementations.

FIG. 3 is a flowchart representation of an exemplary method that adjusts a level of occlusion of a presented representation of a detected object and a presented video in accordance with some implementations.

FIG. 4 illustrates an example of presenting a representation of a detected object and presenting a video in accordance with some implementations.

FIG. 5 illustrates an example of presenting a representation of a detected object and presenting a video in accordance with some implementations.

FIG. 6 illustrates an example of presenting a representation of a detected object and presenting a video in accordance with some implementations.

FIG. 7 illustrates an example of presenting a representation of a detected object and presenting a video in accordance with some implementations.

FIGS. 8A-8C illustrate examples of presenting a representation of a detected object and presenting a video in accordance with some implementations.

In accordance with common practice the various features illustrated in the drawings may not be drawn to scale. Accordingly, the dimensions of the various features may be arbitrarily expanded or reduced for clarity. In addition, some of the drawings may not depict all of the components of a given system, method or device. Finally, like reference numerals may be used to denote like features throughout the specification and figures.

### DESCRIPTION

Numerous details are described in order to provide a thorough understanding of the example implementations shown in the drawings. However, the drawings merely show some example aspects of the present disclosure and are therefore not to be considered limiting. Those of ordinary skill in the art will appreciate that other effective aspects and/or variants do not include all of the specific details described herein. Moreover, well-known systems, methods, components, devices and circuits have not been described in exhaustive detail so as not to obscure more pertinent aspects of the example implementations described herein.

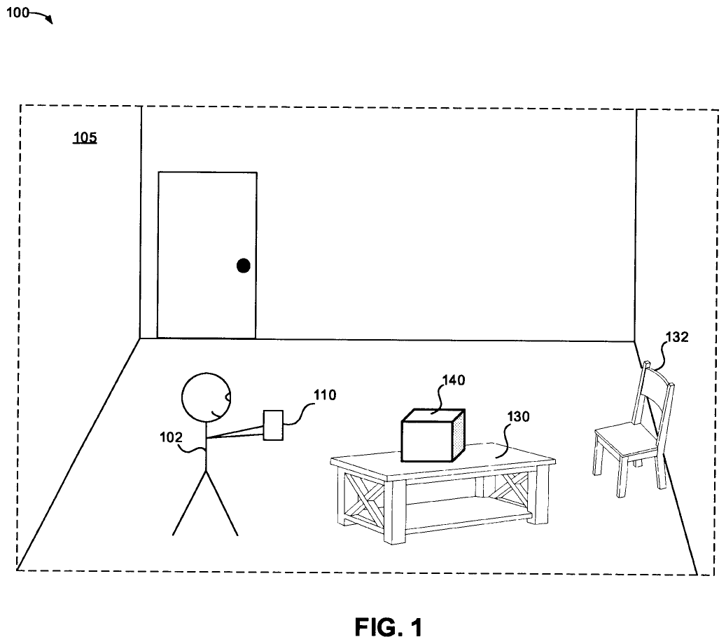

FIG. 1 is a block diagram of an example operating environment 100 in accordance with some implementations. In this example, the example operating environment 100 illustrates an example physical environment 105 that includes a table 130, a chair 132, and an object 140 (e.g., a real object or a virtual object). While pertinent features are shown, those of ordinary skill in the art will appreciate from the present disclosure that various other features have not been illustrated for the sake of brevity and so as not to obscure more pertinent aspects of the example implementations disclosed herein.

In some implementations, the device 110 is configured to present an environment that it generates to the user 102. In some implementations, the device 110 is a handheld electronic device (e.g., a smartphone or a tablet). In some implementations, the user 102 wears the device 110 on his/her head. As such, the device 110 may include one or more displays provided to display content. For example, the device 110 may enclose the field-of-view of the user 102.

In some implementations, the functionalities of device 110 are provided by more than one device. In some implementations, the device 110 communicates with a separate controller or server to manage and coordinate an experience for the user. Such a controller or server may be local or remote relative to the physical environment 105.

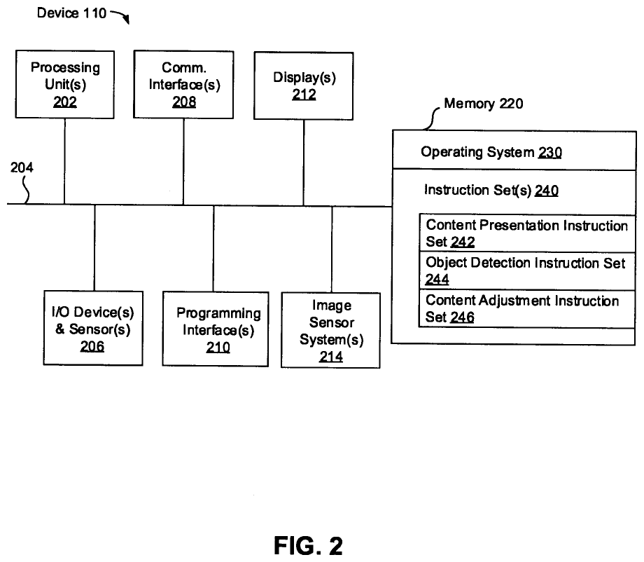

FIG. 2 is a block diagram of an example of the device 110 in accordance with some implementations. While certain specific features are illustrated, those skilled in the art will appreciate from the present disclosure that various other features have not been illustrated for the sake of brevity, and so as not to obscure more pertinent aspects of the implementations disclosed herein. To that end, as a non-limiting example, in some implementations the device 110 includes one or more processing units 202 (e.g., microprocessors, ASICs, FPGAs, GPUs, CPUs, processing cores, and/or the like), one or more input/output (I/O) devices and sensors 206, one or more communication interfaces 208 (e.g., USB, FIREWIRE, THUNDERBOLT, IEEE 802.3x, IEEE 802.11x, IEEE 802.16x, GSM, CDMA, TDMA, GPS, IR, BLUETOOTH, ZIGBEE, SPI, I2C, and/or the like type interface), one or more programming (e.g., I/O) interfaces 210, one or more AR/VR displays 212, one or more interior and/or exterior facing image sensor systems 214, a memory 220, and one or more communication buses 204 for interconnecting these and various other components.

In some implementations, the one or more communication buses 204 include circuitry that interconnects and controls communications between system components. In some implementations, the one or more I/O devices and sensors 206 include at least one of an inertial measurement unit (IMU), an accelerometer, a magnetometer, a gyroscope, a thermometer, an ambient light sensor (ALS), one or more physiological sensors (e.g., blood pressure monitor, heart rate monitor, blood oxygen sensor, blood glucose sensor, etc.), one or more microphones, one or more speakers, a haptics engine, one or more depth sensors (e.g., a structured light, a time-of-flight, or the like), and/or the like.

In some implementations, the one or more displays 212 are configured to present the experience to the user. In some implementations, the one or more displays 212 correspond to holographic, digital light processing (DLP), liquid-crystal display (LCD), liquid-crystal on silicon (LCoS), organic light-emitting field-effect transitory (OLET), organic light-emitting diode (OLED), surface-conduction electron-emitter display (SED), field-emission display (FED), quantum-dot light-emitting diode (QD-LED), micro-electromechanical system (MEMS), and/or the like display types. In some implementations, the one or more displays 212 correspond to diffractive, reflective, polarized, holographic, etc. waveguide displays. For example, the device 110 includes a single display. In another example, the device 110 includes a display for each eye of the user.

In some implementations, the one or more image sensor systems 214 are configured to obtain image data that corresponds to at least a portion of the physical environment 105. For example, the one or more image sensor systems 214 include one or more RGB cameras (e.g., with a complimentary metal-oxide-semiconductor (CMOS) image sensor or a charge-coupled device (CCD) image sensor), monochrome cameras, IR cameras, event-based cameras, and/or the like. In various implementations, the one or more image sensor systems 214 further include illumination sources that emit light, such as a flash. In various implementations, the one or more image sensor systems 214 further include an on-camera image signal processor (ISP) configured to execute a plurality of processing operations on the image data including at least a portion of the processes and techniques described herein.

The memory 220 includes high-speed random-access memory, such as DRAM, SRAM, DDR RAM, or other random-access solid-state memory devices. In some implementations, the memory 220 includes non-volatile memory, such as one or more magnetic disk storage devices, optical disk storage devices, flash memory devices, or other non-volatile solid-state storage devices. The memory 220 optionally includes one or more storage devices remotely located from the one or more processing units 202. The memory 220 includes a non-transitory computer readable storage medium. In some implementations, the memory 220 or the non-transitory computer readable storage medium of the memory 220 stores the following programs, modules and data structures, or a subset thereof including an optional operating system 230 and one or more instruction set(s) 240.

The operating system 230 includes procedures for handling various basic system services and for performing hardware dependent tasks. In some implementations, the instruction set(s) 240 are configured to manage and coordinate one or more experiences for one or more users (e.g., a single experience for one or more users, or multiple experiences for respective groups of one or more users).

The instruction set(s) 240 include a content instruction set 242, an object detection instruction set 244, and a content adjustment instruction set 246. The content instruction set 242, the object detection instruction set 244, and the content adjustment instruction set 246 can be combined into a single application or instruction set or separated into one or more additional applications or instruction sets.

The content presentation instruction set 242 is configured with instructions executable by a processor to provide content on a display of an electronic device (e.g., device 110). For example, the content may include an XR environment that includes depictions of a physical environment including real objects and virtual objects (e.g., a virtual screen overlaid on images of the real-world physical environment). The content presentation instruction set 242 is further configured with instructions executable by a processor to obtain image data (e.g., light intensity data, depth data, etc.), generate virtual data (e.g., a virtual movie screen) and integrate (e.g., fuse) the image data and virtual data (e.g., mixed reality (MR)) using one or more of the techniques disclosed herein.

The object detection instruction set 244 is configured with instructions executable by a processor to analyze the image information and identify objects within the image data. For example, the object detection instruction set 244 analyzes RGB images from a light intensity camera and/or a sparse depth map from a depth camera (e.g., time-of-flight sensor), and other sources of physical environment information (e.g., camera positioning information from a camera's SLAM system, VIO, or the like such as position sensors) to identify objects (e.g., people, pets, etc.) in the sequence of light intensity images. In some implementations, the object detection instruction set 244 uses machine learning for object identification. In some implementations, the machine learning model is a neural network (e.g., an artificial neural network), decision tree, support vector machine, Bayesian network, or the like. For example, the object detection instruction set 244 uses an object detection neural network unit to identify objects and/or an object classification neural network to classify each type of object.

The content adjustment instruction set 246 is configured with instructions executable by a processor to obtain and analyze the object detection data and determine whether the detected object meets a set of criteria in order to adjust a level of occlusion (e.g., to provide breakthrough) between the presented representation of the detected object and a presented video (e.g., a virtual screen). For example, the content adjustment instruction set 246, based on the object detection data, can determine whether the detected object is of a particular type (e.g. a person, pet, etc.), has a particular identity (e.g., a particular person), and/or is at a particular location with respect to the user and/or the virtual screen. That is, the object is within a threshold distance, for example, as an arm's reach of the user, in front of the virtual screen, behind the virtual screen, etc. Additionally, the content adjustment instruction set 246, based on the object detection data, can determine whether the detected object has a particular characteristic (e.g., a moving object, an object moving in a particular way, interacting with the user, not interacting with the user, staring at the user, moving towards the user, moving above a threshold speed, a person who is speaking, speaking in the direction of the user, saying the user's name or an attention seeking phrase, or speaking in a voice having emotional intensity), in order to determine whether to adjust the representation of the detected object (e.g., breaking through the virtual screen with the representation of the detected object).

Although these elements are shown as residing on a single device (e.g., the device 110), it should be understood that in other implementations, any combination of the elements may be located in separate computing devices. Moreover, FIG. 2 is intended more as functional description of the various features which are present in a particular implementation as opposed to a structural schematic of the implementations described herein. As recognized by those of ordinary skill in the art, items shown separately could be combined and some items could be separated. For example, some functional modules (e.g., instruction set(s) 240) shown separately in FIG. 2 could be implemented in a single module and the various functions of single functional blocks (e.g., instruction sets) could be implemented by one or more functional blocks in various implementations. The actual number of modules and the division of particular functions and how features are allocated among them will vary from one implementation to another and, in some implementations, depends in part on the particular combination of hardware, software, and/or firmware chosen for a particular implementation.

According to some implementations, the device 110 may generate and present an extended reality (XR) environment to their respective users. A person can interact with and/or sense a physical environment or physical world without the aid of an electronic device. A physical environment can include physical features, such as a physical object or surface. An example of a physical environment is physical forest that includes physical plants and animals. A person can directly sense and/or interact with a physical environment through various means, such as hearing, sight, taste, touch, and smell. In contrast, a person can use an electronic device to interact with and/or sense an extended reality (XR) environment that is wholly or partially simulated. The XR environment can include mixed reality (MR) content, augmented reality (AR) content, virtual reality (VR) content, and/or the like. With an XR system, some of a person's physical motions, or representations thereof, can be tracked and, in response, characteristics of virtual objects simulated in the XR environment can be adjusted in a manner that complies with at least one law of physics. For instance, the XR system can detect the movement of a user's head and adjust graphical content and auditory content presented to the user similar to how such views and sounds would change in a physical environment. In another example, the XR system can detect movement of an electronic device that presents the XR environment (e.g., a mobile phone, tablet, laptop, or the like) and adjust graphical content and auditory content presented to the user similar to how such views and sounds would change in a physical environment. In some situations, the XR system can adjust characteristic(s) of graphical content in response to other inputs, such as a representation of a physical motion (e.g., a vocal command).

Many different types of electronic systems can enable a user to interact with and/or sense an XR environment. A non-exclusive list of examples include heads-up displays (HUDs), head mountable systems, projection-based systems, windows or vehicle windshields having integrated display capability, displays formed as lenses to be placed on users' eyes (e.g., contact lenses), headphones/earphones, input systems with or without haptic feedback (e.g., wearable or handheld controllers), speaker arrays, smartphones, tablets, and desktop/laptop computers. A head mountable system can have one or more speaker(s) and an opaque display. Other head mountable systems can be configured to accept an opaque external display (e.g., a smartphone). The head mountable system can include one or more image sensors to capture images/video of the physical environment and/or one or more microphones to capture audio of the physical environment. A head mountable system may have a transparent or translucent display, rather than an opaque display. The transparent or translucent display can have a medium through which light is directed to a user's eyes. The display may utilize various display technologies, such as uLEDs, OLEDs, LEDs, liquid crystal on silicon, laser scanning light source, digital light projection, or combinations thereof. An optical waveguide, an optical reflector, a hologram medium, an optical combiner, combinations thereof, or other similar technologies can be used for the medium. In some implementations, the transparent or translucent display can be selectively controlled to become opaque. Projection-based systems can utilize retinal projection technology that projects images onto users' retinas. Projection systems can also project virtual objects into the physical environment (e.g., as a hologram or onto a physical surface).

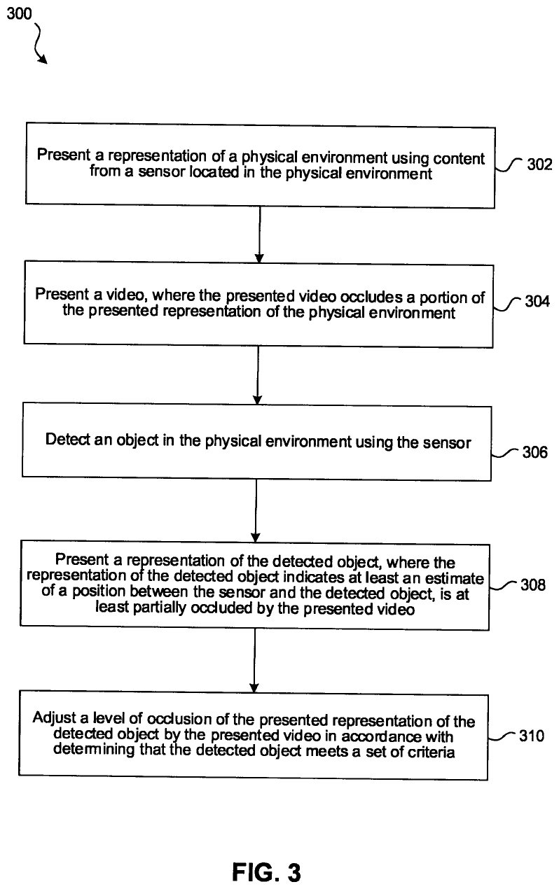

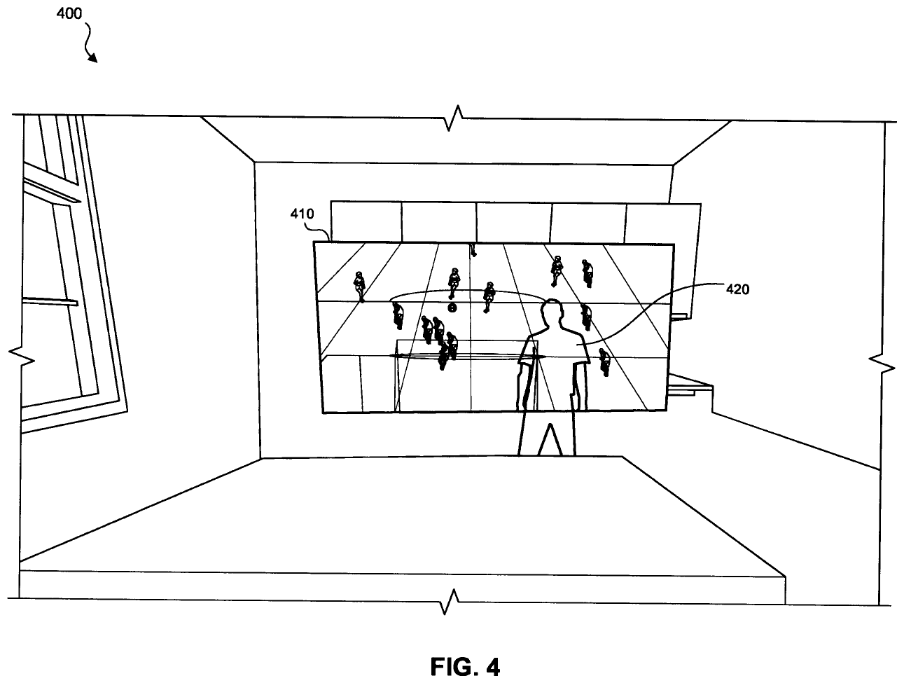

FIG. 3 is a flowchart representation of an exemplary method 300 that adjusts content based on interactions with a detected object during an immersive experience in accordance with some implementations. In some implementations, the method 300 is performed by a device (e.g., device 110 of FIGS. 1 and 2), such as a mobile device, desktop, laptop, or server device. The method 300 can be performed on a device (e.g., device 110 of FIGS. 1 and 2) that has a screen for displaying images and/or a screen for viewing stereoscopic images such as a head-mounted display (HMD). In some implementations, the method 300 is performed by processing logic, including hardware, firmware, software, or a combination thereof. In some implementations, the method 300 is performed by a processor executing code stored in a non-transitory computer-readable medium (e.g., a memory). The content adjustment process of method 300 is illustrated with reference to FIGS. 4-8.

At block 302, the method 300 presents a representation of a physical environment using content from a sensor (e.g., an image sensor, a depth sensor, etc.) located in the physical environment. For example, an outward facing camera (e.g., a light intensity camera) captures passthrough video of a physical environment. Thus, if a user wearing an HMD is sitting in his or her living room, the representation could be pass through video of the living room being shown on the HMD display. In some implementations, a microphone (one of the I/O devices and sensors 206 of device 110 in FIG. 2) may capture sounds in the physical environment and could include sound in the representation.

At block 304, the method 300 presents a video, where the presented video occludes a portion of the presented representation of the physical environment. For example, the presented video is shown overlaid on images (e.g., pass through or optical-see-through video) of the physical environment. The video may be a virtual screen presented on a display of a device. For example, as shown in FIGS. 4-7, a user may be wearing an HMD and viewing the real-world physical environment (e.g., in the kitchen as the presented representation of the physical environment) via pass through video (or optical-see-through video), and a virtual screen may be generated for the user to watch image content or live videos (e.g., a virtual multimedia display). The virtual display or screen is being utilized by the user instead of watching a traditional physical television device/display.

At block 306, the method 300 detects an object (e.g., a person, pet, etc.) in the physical environment using the sensor. For example, an object detection module (e.g., object detection instruction set 244 of FIG. 2) can analyze RGB images from a light intensity camera and/or a sparse depth map from a depth camera (e.g., time-of-flight sensor) and other sources of physical environment information (e.g., camera positioning information from a camera's SLAM system, VIO, or the like such as position sensors) to identify objects (e.g., people, pets, etc.) in the sequence of light intensity images. In some implementations, the object detection instruction set 244 uses machine learning for object identification. In some implementations, the machine learning model is a neural network (e.g., an artificial neural network), decision tree, support vector machine, Bayesian network, or the like. For example, the object detection instruction set 244 uses an object detection neural network unit to identify objects and/or an object classification neural network to classify each type of object.

At block 308, the method 300 presents a representation of the detected object, wherein the representation of the detected object indicates at least an estimate of a position between the sensor and the detected object, and is at least partially occluded by the presented video. For example, a representation of the detected object could be a silhouette of the detected object (e.g., a person, pet, etc.). Alternatively, the representation of the detected object could be using the image data and using pass through video so the image data of the real-world object (the person) is shown instead of a silhouette or other virtual representation (e.g., a 3D rendering) of the detected object.

At block 310, the method 300 adjusts a level of occlusion (e.g., to provide a breakthrough) of the presented representation of the detected object by the presented video in accordance with determining that the detected object meets a set of criteria. For example, the criteria can include whether the object is of a particular type (e.g. a person, pet, etc.), has a particular identity (e.g., a particular person), and/or is at a particular location with respect to the user and/or the virtual screen. That is the object is within a threshold distance, for example, such as an arm's reach of the user, in front of the virtual screen, behind the virtual screen, etc.

Additionally, or alternatively, the criteria could further include whether the object has or exhibits a particular characteristic. For example, the criteria could include whether the detected object is a moving object, or whether the detected object is moving in a particular way (e.g., walking or running). As an additional example, the criteria could include whether the detected object is interacting with the user (e.g., a person waving at a person) or not interacting with the user (e.g., working on task or chore at home and facing away from the user). As an additional example, the criteria could include whether the detected object is staring at the user. As an additional example, the criteria could include whether the detected object is moving towards the user. Other criteria may further include whether the detected object is moving above a threshold speed, whether a person is speaking, whether a person is speaking in the direction of the user, whether a person is saying the user's name or an attention seeking phrase, and/or whether a person is speaking in a voice having emotional intensity (e.g., yelling at the user).

In some implementations, determining that the detected object meets the set of criteria include determining that an object type of the detected object meets the set of criteria. For example, it may be desirable to determine that a detected object is a person as opposed to a pet that is approaching the user. Thus, the techniques described herein may process and present a breakthrough for a person differently than for a pet (e.g., breakthrough elements and the avatar for a person may be more distinct and attention grabbing for the user than breakthrough elements and the avatar for a pet or other object).

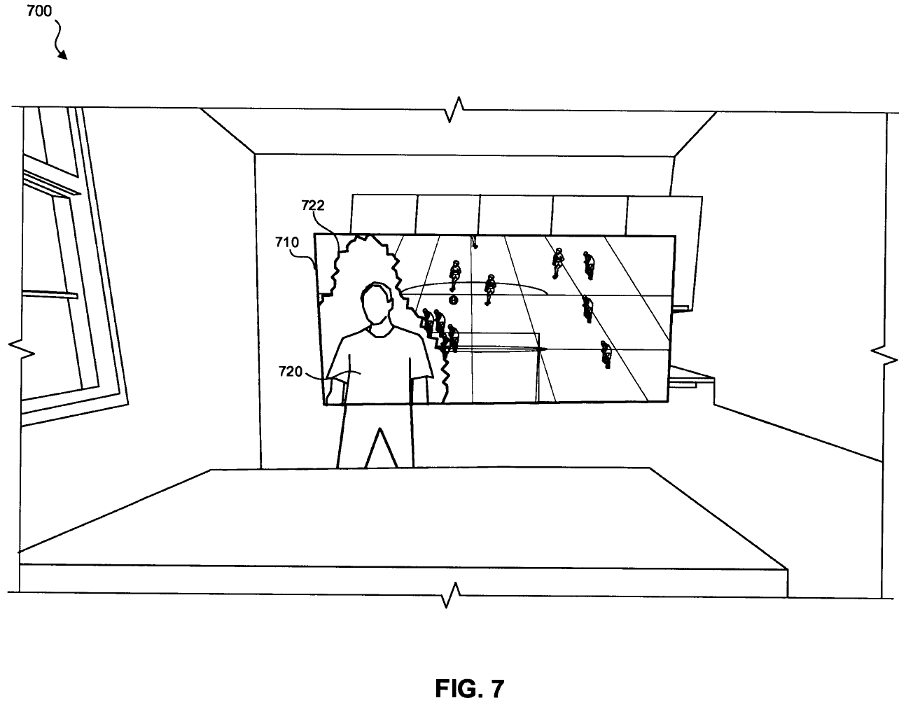

In some implementations, detecting the object in the physical environment includes determining a location of the object, and determining that the detected object meets the set of criteria includes determining that the location of the detected object meets the set of criteria. For example, the techniques described herein may determine a location of the user and determine a location of the detected object and determine whether the detected object is within a threshold distance. For example, a threshold distance could be determined as within an arm's reach of the user, or less than a preset distance such as within the social distant rule—six feet). Additionally, or alternatively, the techniques described herein may determine a location of the detected object (e.g., a person) and determine whether the detected object is in front of a virtual screen or behind the virtual screen. Moreover, as further described herein with reference to FIGS. 4-8, different rules of breakthrough for the detected object may apply based on the location of the detected object. For example, an exemplary rule may specify for a detected person behind the virtual screen show a silhouette of the detected person (e.g., FIG. 4), and for a detected person in front of the screen show a representation of the detected object. For example, in these different circumstances, the rule may specify whether to pass through video of the real-world detected object, or show a 3D rendering of the detected object (e.g., FIG. 7).

In some implementations, detecting the object in the physical environment includes determining a movement of the detected object, and determining that the detected object meets the set of criteria includes determining that the movement of the detected object meets the set of criteria. For example, determining that the movement of the detected object meets the set of criteria may include determining a direction of movement (e.g., towards the user). Moreover, determining that the movement of the detected object meets the set of criteria may include determining a speed of movement. For example if a detected object, which may be at a farther distance than most objects, is moving very quickly towards the user, the techniques described herein may provide an alert to the user or breakthrough with the object because something may be urgent or it may be a safety measure to warn the user that a detected object is moving quickly towards the user. Additionally, determining that the movement of the detected object meets the set of criteria may include determining that a movement is indicative of interaction with the user (e.g., a person is waving at the user) or that a movement indicative of non-interaction with the user (e.g., a person is walking through the room and not moving towards the user).

In some implementations, the detected object is a person, and determining that the detected object meets the set of criteria includes determining that an identity of the person meets the set of criteria. For example, determining that an identity of the person meets the set of criteria may include determining that the person is of importance (e.g., a user's spouse) and the techniques described herein may provide breakthrough anytime the person of importance enters the room and is in view of the user. Additionally, determining that an identity of the person meets the set of criteria may include determining that the person is not of importance (e.g., a stranger) or is part of an excluded list (e.g., an in-law) and the techniques described herein may prevent breakthrough. In some implementations, presenting a breakthrough for detected objects exhibiting a characteristic indicative of attention-seeking behavior is affected by a priority list or an exclusion list. For example, a priority list or an exclusion list may assist users of the techniques described herein with assigning different classifications to objects. A user may identify specific objects or people (e.g., the user's partner and/or children) on a priority list for preferential treatment. Using the priority list, the techniques described herein may automatically inject a visual representation of such objects (or people) into an XR environment presented to the user. Also, a user may identify specific objects or people (e.g., the user's in-law's) on an exclusion list for less than preferential treatment. Using the exclusion list, the techniques described herein may refrain from injecting any visual representations of such objects (or people) into an XR environment presented to the user.

In some implementations, the detected object is a person, and detecting the object in the physical environment includes determining speech associated with the person and determining that the detected object meets the set of criteria includes determining that the speech associated with the person meets the set of criteria. For example, determining that the person is speaking, speaking in the direction of the user, saying a name of the user or an attention seeking phrase, and/or speaking in a voice that includes some level of emotional intensity, the techniques described herein may than present a representation of the detected object (e.g., a breakthrough on the virtual screen). Or, in some implementations, based on a similar determination of the speech of the detected object (a person), the techniques described herein may prevent a presentation of a representation of the detected object (e.g., prevent a breakthrough and show only a silhouette, or do not show a representation or indication at all to the user that a person is present).

In some implementations, the detected object is a person, and detecting the object in the physical environment includes determining a gaze direction of the person and determining that the detected object meets the set of criteria includes determining that the gaze direction of the person meets the set of criteria. For example, the device 110 may use eye tracking technology to determine that a person is looking at the user based on the person's gaze towards the user. For example, obtaining eye gaze characteristic data associated with a gaze of a person may involve obtaining images of the eye from which gaze direction and/or eye movement can be determined.

In some implementations, the method 300 involves adjusting the level of immersion and/or adjusting a level of the breakthrough of the detected object based on an immersion level. An immersion level refers to how much of the real-world is presented to the user in the pass-through video. For example, immersion level may refer to how much of a virtual screen versus how much of the real-world is being shown. In another example, immersion level refers to how virtual and real world content is displayed. For example, deeper immersion levels may fade or darken real world content so more user attention is on the virtual screen (e.g., a movie theater) or other virtual content. In some implementations, adjusting the level of immersion of the presented representation of the detected object adjusts how much of a view includes virtual content compared to physical content of the physical environment. In some implementations, at different immersion levels, pass-through content may or may not be displayed in certain areas. For example, at one immersion level, the user may be fully immersed watching a movie in a virtual movie theater. At another immersion level, the user may be watching the movie without any virtual content outside of the virtual screen (e.g. via diffused lighting in the representation of the physical environment).

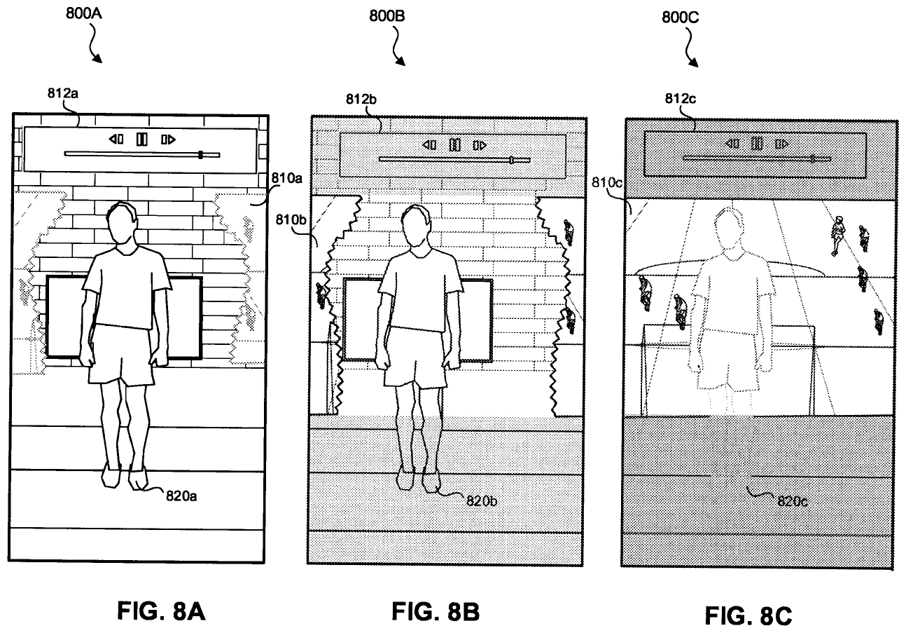

The level of breakthrough may be adjusted based on the level of immersion. In one example, the more immersive the experience, the more subtle the breakthrough (e.g., for a movie theater immersion level, the breakthrough may be less obtrusive when showing a person as breaking through to the user). Adjusting the level of immersion or adjusting a level of the breakthrough of the detected object based on an immersion level is further described herein with reference to FIGS. 8A-8C.

In some implementations, the method 300 involves pausing playback and resuming playback of the presented video. The pausing and resumption may be based on characteristics of the detected object and/or the user's response. For example, pausing may be based on the intensity (e.g., duration, volume, and/or direction of audio) of the interruption from the detected object. The resumption may be automatic based on detecting a change in the characteristics used to initiate the pausing, e.g., lack of intensity, etc. The video may restart with a buffer (e.g., restarting at an earlier playtime, e.g., five seconds before the point that was being played when the interruption started). In particular, in some implementations, the method 300 may further include pausing the playback of the video in accordance with determining that the detected object meets the set of criteria. For example, the video may be paused while a detected person is shown in breakthrough and then the video may be resumed when the interaction/breakthrough concludes. In particular, in some implementations, the method 300 may further include resuming playback of the video in accordance with determining that the detected object meets a second set of criteria. In some implementations, the playback of the video is resumed using video content prior to the pausing (e.g., a five second buffer to replay what is missed).

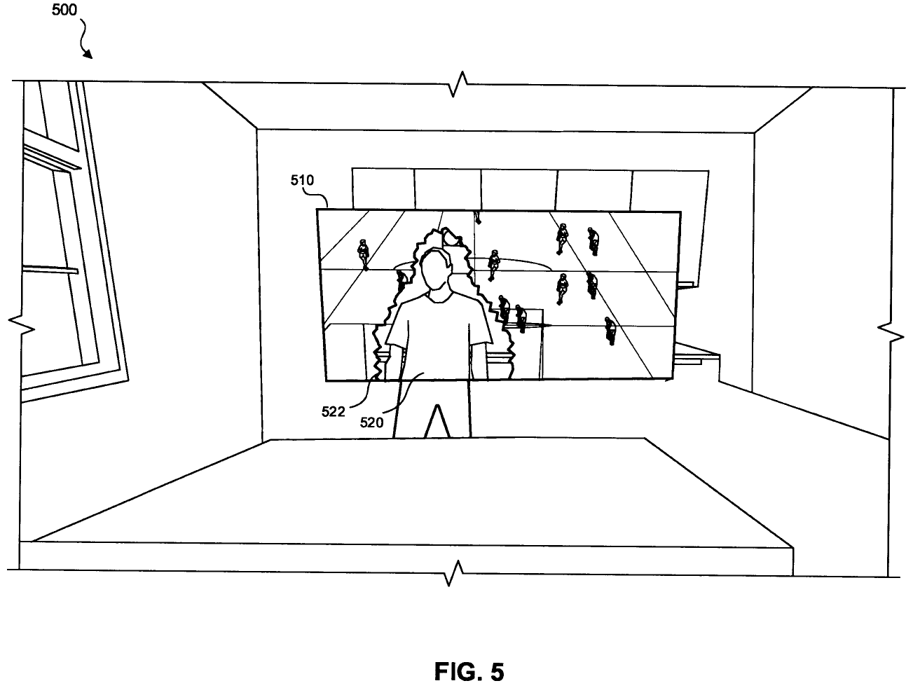

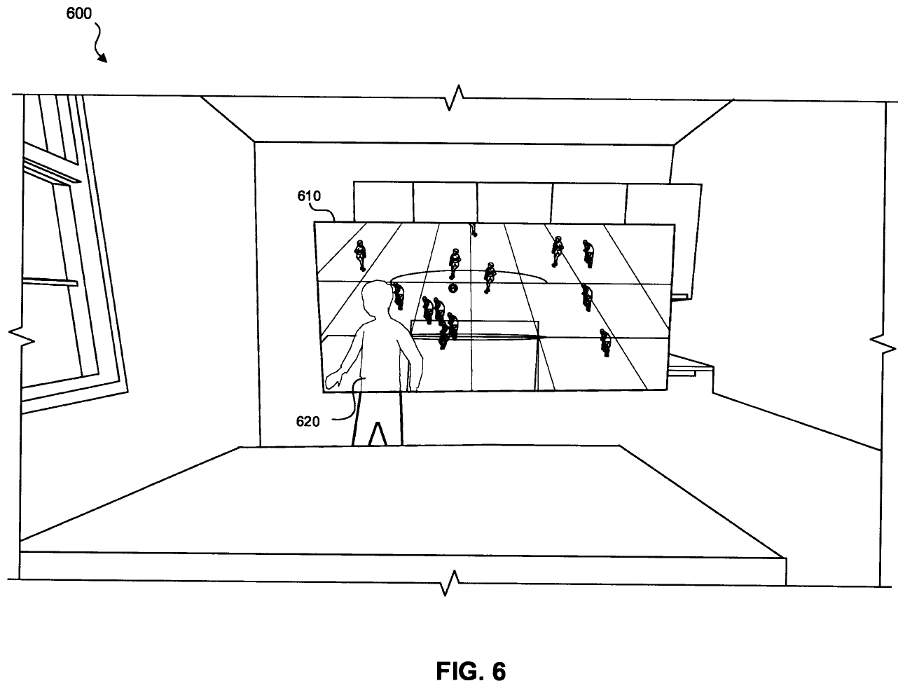

The presentation of representations of physical environments, representations of detected objects, and videos (e.g., on virtual screens) are further described herein with reference to FIGS. 4-8. In particular, FIGS. 4 and 5 illustrate examples of a user watching a video on a virtual screen where another person is physically behind the screen (e.g., not socially interacting in FIG. 4, and socially interacting, and thus breaking through, in FIG. 5). FIGS. 6 and 7 illustrate examples of a user watching a video on a virtual screen where another person is physically in front of the screen (e.g., not socially interacting in FIG. 6 and socially interacting, and thus breaking through, in FIG. 7). FIG. 8 illustrates how breaking through may be different based on a level of immersion in which the user is current viewing the video content (e.g., casually, or engrossed in a movie theater setting).

FIG. 4 illustrates an example environment 400 of presenting a representation of a physical environment, presenting a video, detecting an object (e.g., a person), and presenting a representation of the detected object and in accordance with some implementations. In particular, FIG. 4 illustrates a user's perspective of watching content (e.g., a video) on a virtual screen 410 that is overlaid or placed within a representation of real-world content (e.g., pass-through video of the user's kitchen). In this example, environment 400 illustrates a person walking behind the virtual screen 410 (e.g., the virtual screen 410 appears closer to the user than the actual distance the person), and the person is not interacting with the user based on one or more criteria described herein. That is, the person has satisfied the one or more criteria, for example, no social interaction, not talking to or at the user, not moving towards the user, etc. According to techniques described herein, the person may be illustrated to the user as a silhouette 420 (e.g., a shadow or outline of the person located behind the virtual screen 410). Thus, the user is watching television (e.g., a live soccer match), and the other person is walking behind the virtual screen 410, and the user can see that the person is there as silhouette 420, but that person is not shown to the user as “breaking through” for the reasons described herein (e.g., no social interacting).

FIG. 5 illustrates an example environment 500 of presenting a representation of a physical environment, presenting a video, detecting an object (e.g., a person), and presenting a representation of the detected object and in accordance with some implementations. In particular, FIG. 5 illustrates a user's perspective of watching content (e.g., a video) on a virtual screen 510 that is overlaid or placed within a representation of real-world content (e.g., pass-through video of the user's kitchen). In this example, environment 500, similar to environment 400, illustrates a person that is located behind the virtual screen 510 (e.g., the virtual screen 510 appears closer to the user than the actual distance the person). However, as opposed to the person in environment 400 that is not interacting with the user, here in environment 500, the person is interacting with the user based on one or more criteria described herein (e.g., social interacting by either talking to or at the user, is moving towards the user, waving at the user, etc.), and is being shown as breaking through the virtual screen 510 as an avatar 520 via the breakthrough lines 522 in the virtual screen 510. According to techniques described herein, the person may be illustrated to the user as an avatar 520 (e.g., a 3D rendering or representation of the person, or could be pass-through video and be images of the person that is breaking through the virtual screen 510). Thus, the user is watching television (e.g., a live soccer match), and the other person is behind the virtual screen 510 and is socially interacting with the user. Therefore, the user can see the person as an avatar 520, and the person is shown as “breaking through” the virtual screen 510 via the breakthrough lines 522 for the reasons described herein. That is the person has satisfied one or more of the breakthrough criteria by, for example, interacting with the user).

FIG. 6 illustrates an example environment 600 of presenting a representation of a physical environment, presenting a video, detecting an object (e.g., a person), and presenting a representation of the detected object and in accordance with some implementations. In particular, FIG. 6 illustrates a user's perspective of watching content (e.g., a video) on a virtual screen 610 that is overlaid or placed within a representation of real-world content (e.g., pass-through video of the user's kitchen). In this example, environment 600 illustrates a person walking in front of the virtual screen 610. That is, the virtual screen 610 appears farther away to the user than the actual distance the person. Additionally, the person is not interacting with the user based on one or more criteria described herein. That is the person is not, for example, social interacting, not talking to or at the user, not moving towards the user, etc. According to techniques described herein, the person may be illustrated to the user as a silhouette 620 (e.g., a shadow or outline of the person located in front of the virtual screen 610). Thus, the user is watching television (e.g., a live soccer match), and the other person is walking in front of the virtual screen 620, and the user can see that a person is there as silhouette 620, but that person is not shown to the user as “breaking through” for the reasons described herein (e.g., no social interacting). Indeed, in the example of FIG. 6, the device is prioritizing the display of virtual screen over the display of the person, who is closer to the user than computer-generated position of the virtual screen, by obfuscating the person with silhouette 620. In some embodiments, the silhouette may be translucent to permit continued viewing of information on virtual screen 610.

FIG. 7 illustrates an example environment 700 of presenting a representation of a physical environment, presenting a video, detecting an object (e.g., a person), and presenting a representation of the detected object and in accordance with some implementations. In particular, FIG. 7 illustrates a user's perspective of watching content (e.g., a video) on a virtual screen 710 that is overlaid or placed within a representation of real-world content (e.g., pass-through video of the user's kitchen). In this example, environment 700, similar to environment 600, illustrates a person that is located in front of the virtual screen 710 (e.g., the virtual screen 710 appears farther away to the user than the actual distance of the person). However, as opposed to the person in environment 600 that is not interacting with the user, here in environment 700, the person is interacting with the user based on one or more criteria described herein. That is the person is social interacting by either talking to or at the user, is moving towards the user, waving at the user, and the like. Additionally, the person is being shown to the user as breaking through the virtual screen 710 as an avatar 720 via the breakthrough lines 722 in the virtual screen 710. According to techniques described herein, the person may be illustrated to the user as an avatar 720 (e.g., a 3D rendering or representation of the person, or could be pass-through video and be images of the person that is breaking through the virtual screen 710). Thus, the user is watching television (e.g., a live soccer match), and the other person is in front of the virtual screen 710 and is socially interacting with the user. Therefore, the user can see the person as an avatar 720, and the person is shown as “breaking through” the virtual screen 710 via the breakthrough lines 722 for the reasons described herein (e.g., the person has satisfied one or more of the breakthrough criteria, i.e., the person is social interacting with the user).

FIGS. 8A-8C illustrate example environments 800A, 800B, 800C, respectively, of presenting a representation of a physical environment, presenting a video, detecting an object (e.g., a person), and presenting a representation of the detected object and in accordance with some implementations. In particular, FIGS. 8A-8C illustrate a user's perspective of watching content (e.g., a video) on a virtual screen 810a, 810b, and 810c that is overlaid or placed within a representation of real-world content (e.g., pass-through video of the user's kitchen), and a detected object (e.g., a person) is shown as breaking through the virtual screen, but at different levels of immersion. For example, environment 800A is an example of a first level of immersion, such as watching a live sporting event casually (e.g., normal lighting conditions), where the user may adjust a setting to allow all interactions. Thus, when the person does break through for the reasons described herein. That is the person has satisfied one or more of the breakthrough criteria by, for example, social interacting with the user. Moreover, the avatar 820a of the person is predominantly shown, and the virtually screen 810a is not shown as much. On other end of the immersion levels, environment 800C is an example of a third level of immersion, such as watching a movie in a movie theater setting (e.g., very dark lighting conditions), where the user may adjust a setting to not allow interactions, or only allow interactions that are direct social interactions, or only allow particular social interactions from people that may be on a priority list as described herein. Thus, the avatar 820c of the person is not predominantly shown even though the person does breakthrough for the reasons described herein. That is the person has satisfied one or more of the breakthrough criteria by, for example, social interacting with the user. Additionally, there are not breakthrough lines or are not shown as predominantly, and the virtually screen 810c is shown more, as compared to virtual screen 810a and 810b. Environment 800B is an example of a second or middle level of immersion. For example, environment 800B may include a level of immersion somewhere between casually viewing television in environment 800A, and a theater mode in environment 800C.

In some embodiments, virtual controls 812a, 812b, and 812c (also referred to herein as virtual controls 812), may be implemented that allows a user to control the virtual content on the virtual screen (e.g., normal controls for pause, rewind, fast forward, volume, etc.). Additionally, or alternatively, virtual controls 812 may be implemented that allows a user to control the settings for the level of immersion. For example, a user can change modes (e.g., level of immersion) using the virtual controls 812. Additionally, or alternatively, virtual controls 812 can allow a user to pause playback and resume playback of the presented video (e.g., override the playback features as described herein). For example, after a social interaction with a user, the playback maybe automatically paused based on the intensity (e.g., duration, volume, direction of audio) of the interruption from the detected object, and although resumption may be automatic based on lack of intensity, and can restart with a buffer (e.g., five more seconds than where the interruption started), the virtual controls 812 can also be utilized by the user to restart the video content on the virtual screen 810 without having to wait for the automatic resumption.

Numerous specific details are provided herein to afford those skilled in the art a thorough understanding of the claimed subject matter. However, the claimed subject matter may be practiced without these details. In other instances, methods, apparatuses, or systems, that would be known by one of ordinary skill, have not been described in detail so as not to obscure claimed subject matter.

Implementations of the methods disclosed herein may be performed in the operation of such computing devices. The order of the blocks presented in the examples above can be varied for example, blocks can be re-ordered, combined, and/or broken into sub-blocks. Certain blocks or processes can be performed in parallel.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus. Alternatively, or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures. Unless specifically stated otherwise, it is appreciated that throughout this specification discussions utilizing the terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

The system or systems discussed herein are not limited to any particular hardware architecture or configuration. A computing device can include any suitable arrangement of components that provides a result conditioned on one or more inputs. Suitable computing devices include multipurpose microprocessor-based computer systems accessing stored software that programs or configures the computing system from a general purpose computing apparatus to a specialized computing apparatus implementing one or more implementations of the present subject matter. Any suitable programming, scripting, or other type of language or combinations of languages may be used to implement the teachings contained herein in software to be used in programming or configuring a computing device.

Implementations of the methods disclosed herein may be performed in the operation of such computing devices. The order of the blocks presented in the examples above can be varied for example, blocks can be re-ordered, combined, and/or broken into sub-blocks. Certain blocks or processes can be performed in parallel.

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or value beyond those recited. Headings, lists, and numbering included herein are for ease of explanation only and are not meant to be limiting.

It will also be understood that, although the terms “first,” “second,” etc. may be used herein to describe various elements, these elements should not be limited by these terms. These terms are only used to distinguish one element from another. For example, a first node could be termed a second node, and, similarly, a second node could be termed a first node, which changing the meaning of the description, so long as all occurrences of the “first node” are renamed consistently and all occurrences of the “second node” are renamed consistently. The first node and the second node are both nodes, but they are not the same node.

The terminology used herein is for the purpose of describing particular implementations only and is not intended to be limiting of the claims. As used in the description of the implementations and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A non-transitory computer-readable storage medium, storing program instructions executable by one or more processors to perform operations comprising:
presenting a representation of a physical environment using content obtained using a sensor located in the physical environment;
presenting a video, wherein the presented video occludes a portion of the presented representation of the physical environment;
detecting an object in the physical environment using the sensor;
presenting a representation of the detected object, wherein the representation of the detected object:
indicates at least an estimate of a position between the sensor and the detected object, and
is at least partially occluded by the presented video; and
in accordance with determining that the detected object meets a set of criteria, adjusting a level of occlusion of the presented representation of the detected object by the presented video.

2. The non-transitory computer-readable storage medium of claim 1, wherein determining that the detected object meets the set of criteria comprises determining that an object type of the detected object meets the set of criteria.

3. The non-transitory computer-readable storage medium of claim 1, wherein:
detecting the object in the physical environment comprises determining a location of the object, and
determining that the detected object meets the set of criteria comprises determining that the location of the detected object meets the set of criteria.

4. The non-transitory computer-readable storage medium of claim 1, wherein:
detecting the object in the physical environment comprises determining a movement of the detected object; and
determining that the detected object meets the set of criteria comprises determining that the movement of the detected object meets the set of criteria.

5. The non-transitory computer-readable storage medium of claim 1, wherein:
the detected object is a person; and
determining that the detected object meets the set of criteria comprises determining that an identity of the person meets the set of criteria.

6. The non-transitory computer-readable storage medium of claim 1, wherein:
the detected object is a person;
detecting the object in the physical environment comprises determining speech associated with the person; and
determining that the detected object meets the set of criteria comprises determining that the speech associated with the person meets the set of criteria.

7. The non-transitory computer-readable storage medium of claim 1, wherein:
the detected object is a person;
detecting the object in the physical environment comprises determining a gaze direction of the person; and
determining that the detected object meets the set of criteria comprises determining that the gaze direction of the person meets the set of criteria.

8. The non-transitory computer-readable storage medium of claim 1, wherein adjusting the level of occlusion of the presented representation of the detected object is based on how much of the representation of the content comprises virtual content compared to physical content of the physical environment.

9. The non-transitory computer-readable storage medium of claim 1, wherein the operations further comprise:
in accordance with determining that the detected object meets the set of criteria, pausing the playback of the video.

10. The non-transitory computer-readable storage medium of claim 9, wherein the operations further comprise:
in accordance with determining that the detected object meets a second set of criteria, resuming playback of the video.

11. The non-transitory computer-readable storage medium of claim 10, wherein the playback of the video is resumed using video content prior to the pausing.

12. A device comprising:
a non-transitory computer-readable storage medium; and
one or more processors coupled to the non-transitory computer-readable storage medium, wherein the non-transitory computer-readable storage medium comprises program instructions that, when executed on the one or more processors, cause the system to perform operations comprising:
presenting a representation of a physical environment using content from a sensor located in the physical environment;
presenting a video, wherein the presented video occludes a portion of the presented representation of the physical environment;
detecting an object in the physical environment using the sensor;
presenting a representation of the detected object, wherein the representation of the detected object:
indicates at least an estimate of a position between the sensor and the detected object, and
is at least partially occluded by the presented video; and
in accordance with determining that the detected object meets a set of criteria, adjusting a level of occlusion of the presented representation of the detected object by the presented video.

13. The device of claim 12, wherein:
detecting the object in the physical environment comprises determining a location of the object, and
determining that the detected object meets the set of criteria comprises determining that the location of the detected object meets the set of criteria.

14. The device of claim 12, wherein:
detecting the object in the physical environment comprises determining a movement of the detected object; and
determining that the detected object meets the set of criteria comprises determining that the movement of the detected object meets the set of criteria.

15. The device of claim 12, wherein:
the detected object is a person; and
determining that the detected object meets the set of criteria comprises determining that an identity of the person meets the set of criteria.

16. The device of claim 12, wherein:
the detected object is a person;
detecting the object in the physical environment comprises determining speech associated with the person; and
determining that the detected object meets the set of criteria comprises determining that the speech associated with the person meets the set of criteria.

17. The device of claim 12, wherein:
the detected object is a person;
detecting the object in the physical environment comprises determining a gaze direction of the person; and
determining that the detected object meets the set of criteria comprises determining that the gaze direction of the person meets the set of criteria.

18. The device of claim 12, wherein adjusting the level of occlusion of the presented representation of the detected object is based on how much of the representation of the content comprises virtual content compared to physical content of the physical environment.

19. The device of claim 12, wherein the operations further comprise:
in accordance with determining that the detected object meets the set of criteria, pausing the playback of the video.

20. A method comprising:
at an electronic device having a processor:
presenting a representation of a physical environment using content from a sensor located in the physical environment;
presenting a video, wherein the presented video occludes a portion of the presented representation of the physical environment;
detecting an object in the physical environment using the sensor;
presenting a representation of the detected object, wherein the representation of the detected object:
indicates at least an estimate of a position between the sensor and the detected object, and
is at least partially occluded by the presented video; and
in accordance with determining that the detected object meets a set of criteria, adjusting a level of occlusion of the presented representation of the detected object by the presented video.
